(19) United States
(12) Patent Application Publication
(10) Pub. No.: US 2026/0152981 A1
(43) Pub. Date: Jun. 4, 2026

(54) HINGE ASSEMBLY WITH LOCKING MECHANISM FOR LID AND CONTAINER ENGAGEMENT

(71) Applicant: Nickolas Brands, LLC, Sarasota, FL (US)

(72) Inventors: Nickolas Reinhart, Sarasota, FL (US); Joe Klein, Findlay, OH (US); Ben Sayalith, Findlay, OH (US)

(21) Appl. No.: 19/409,134

(22) Filed: Dec. 4, 2025

Related U.S. Application Data
(60) Provisional application No. 63/727,781, filed on Dec. 4, 2024.

(51) Int. Cl. E05D 3/02; E05D 5/12; E05D 5/10

(52) U.S. Cl. CPC E05D 3/02; E05D 5/12; E05D 2005/102; E05Y 2600/50

(57) ABSTRACT

A hinge assembly for coupling a lid to a container is provided. The hinge assembly includes a lid, a container, a hinge pin having first and second ends. The hinge pin includes a linear portion interrupted by a bend forming a protrusion. The lid includes a first pair of knuckles connected by a first channel and the container includes a second pair of knuckles connected by a second channel. The first and second knuckles align to cooperatively form a hinge pin channel that receives the hinge pin. The protrusion of the hinge pin engages an opening in the second channel of the second pair of knuckles to lock and retain the hinge pin in the hinge pin channel while allowing rotational movement of the lid relative to the container. A method of coupling a lid and container using the hinge assembly is also provided.

### CROSS-REFERENCE TO RELATED APPLICATIONS

This application claims the benefit of U.S. Provisional Application No. 63/727,781, filed on December 4, 2024. The entire disclosure of the above application is incorporated herein by reference.

### FIELD

The present technology relates to hinge assemblies for coupling components, and, more particularly, to a hinge assembly for pivotally joining a lid to a container.

### INTRODUCTION

This section provides background information related to the present disclosure which is not necessarily prior art.

A hinge mechanism may be used to pivotally join components, such as a lid and a container. The hinge mechanism may allow the two components to rotate or pivot relative to each other around a fixed axis. The hinge mechanism may be utilized in a box with a lid, a storage container, an organizer, or the like, to provide temporary access to an interior for storage or organization. The hinge mechanism may present certain challenges in terms of durability, ease of assembly, and security.

One issue is the tendency for a hinge pin of the hinge mechanism to dislodge or become loose during operation. This issue may be prevalent in an application where the hinged component is subjected to frequent use or significant stress. The unintended separation of the hinge pin from a hinge socket may also lead to failure of the hinge mechanism. Failure of the hinge mechanism may render the product unusable, and may require replacement or repair of the hinge mechanism, which may be costly.

Another challenge includes the complexity of a hinge assembly. Certain hinge assemblies may require specialized tools or complex procedures to properly align and secure the hinge pin within the hinge socket. Some configurations may include intricate details and configurations that frustrate the ease of use of the hinge mechanism. This complexity not only increases manufacturing costs, but may also make field repair and replacement more difficult and time-consuming.

Another limitation to the hinge assembly may be the employment of a certain locking feature to retain the hinge pin and militate against unintended disassembly during use. Certain locking features may include an external fastener such as a cotter pin, a set screw, a clip, or other retaining rings that may be inserted through pre-drilled or post-drilled holes after the pin has been installed. Other locking features may include a threaded hinge pin with a nut or a cap that may secure the hinge pin at one or both ends. Other hinge assemblies may incorporate separate locking components that engage grooves machined into the hinge pin shaft. Undesirably, these locking features may require additional manufacturing steps to create the necessary holes, threads, or grooves in the hinge pin or hinge assembly, which may increase the overall part count and assembly complexity, necessitate specialized tools for installation and removal, and add to the material and labor costs of producing the hinge assembly. Furthermore, external locking components may also be susceptible to loss, corrosion, or failure over time, potentially compromising the integrity and security of the hinge mechanism.

There is a continuing need for an improved hinge assembly that provides enhanced retention of the hinge pin and simplifies the assembly process, while maintaining smooth operational characteristics and including a locking mechanism built integral with the hinge assembly without the need for external tools or fasteners to secure the hinge pin for pivotally coupling a lid to a container.

### SUMMARY

In concordance with the instant disclosure, an improved hinge assembly that provides enhanced retention of the hinge pin and simplifies the assembly process, while maintaining smooth operational characteristics and including a locking mechanism built integral with the hinge assembly without the need for external tools or fasteners to secure the hinge pin for pivotally coupling a lid to a container, has surprisingly been discovered.

The present technology includes articles of manufacture, systems, and processes that relate to hinge assemblies for coupling a lid to a container.

In certain embodiments, a hinge assembly is provided. The hinge assembly may include a hinge pin with a first end, a second end, and a linear portion. The linear portion may be disrupted by a bend forming a protrusion in the linear portion. The hinge assembly may also include a first pair of knuckles formed on the lid where each knuckle may be connected by a first channel. The hinge assembly may also include a second pair of knuckles formed on the container where each knuckle may be connected by a second channel. The first pair of knuckles may be configured to align with the second pair of knuckles such that the first channel and the second channel may cooperate to form a hinge pin channel. The hinge pin channel may be configured to receive the hinge pin. The configuration of the hinge pin with the protrusion formed by the bend in the linear portion may enable the hinge pin to be secured within the hinge pin channel, thereby pivotally coupling the lid to the container without requiring external fasteners or tools.

In certain embodiments, a method of pivotally coupling a lid and container may be provided. The method may include a step of aligning the first channel of the first pair of knuckles of the lid with the second channel of the second pair of knuckles of the container to form the hinge pin channel. The method may include a step of inserting the hinge pin from the second end through the hinge pin channel to pivotally join the lid and the container. The method may include a step of receiving the protrusion of the hinge pin in the second pair of knuckles to lock the hinge pin in the hinge pin channel.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a hinge for a hinge assembly, according to an embodiment of the present disclosure.

FIG. 2 is a rear elevational view of the hinge pin shown in FIG. 1.

FIG. 3 is a front elevational view of the hinge pin shown in FIG. 1.

FIG. 4 is a top plan view of the hinge pin shown in FIG. 1.

FIG. 5 is a bottom plan view of the hinge pin shown in FIG. 1.

FIG. 6 is left side elevational view of the hinge pin shown in FIG. 1.

FIG. 7 is a right side elevational view of the hinge pin shown in FIG. 1.

FIG. 8 is an exploded view of a hinge assembly, according to an embodiment of the present disclosure.

FIG. 9 is an assembly view of a container and lid with the hinge assembly, according to an embodiment of the present disclosure.

FIGS. 10-11 are enlarged, exploded views of the hinge assembly.

FIG. 12 is an enlarged top perspective view of the hinge assembly.

FIG. 13 is an enlarged bottom perspective view of the hinge assembly.

FIG. 14 is a cross-sectional view of the hinge assembly.

FIG. 15 is a flowchart illustrating a method of pivotally coupling a lid to a container using the hinge assembly, according to yet another embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1–10, or 2–9, or 3–8, it is also envisioned that Parameter X may have other ranges of values including 1–9, 1–8, 1–3, 1–2, 2–10, 2–8, 2–3, 3–10, 3–9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

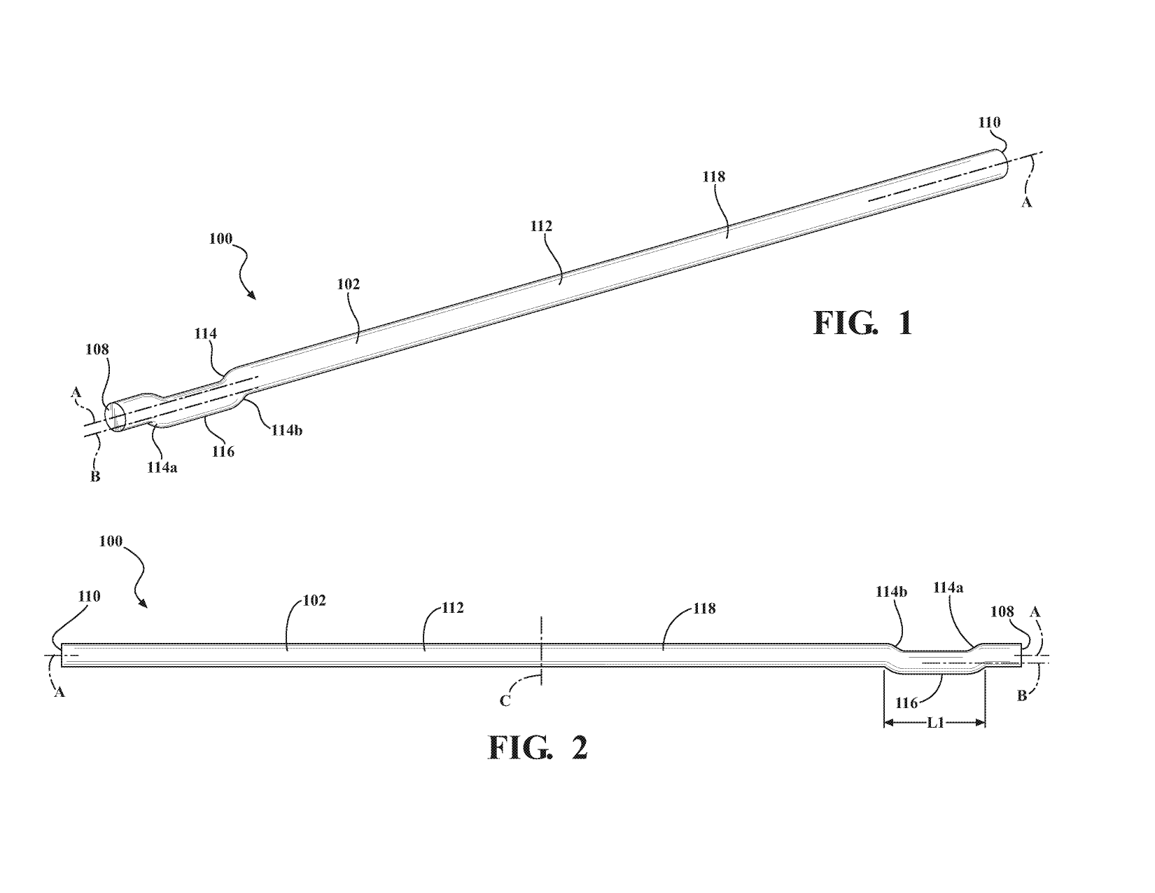

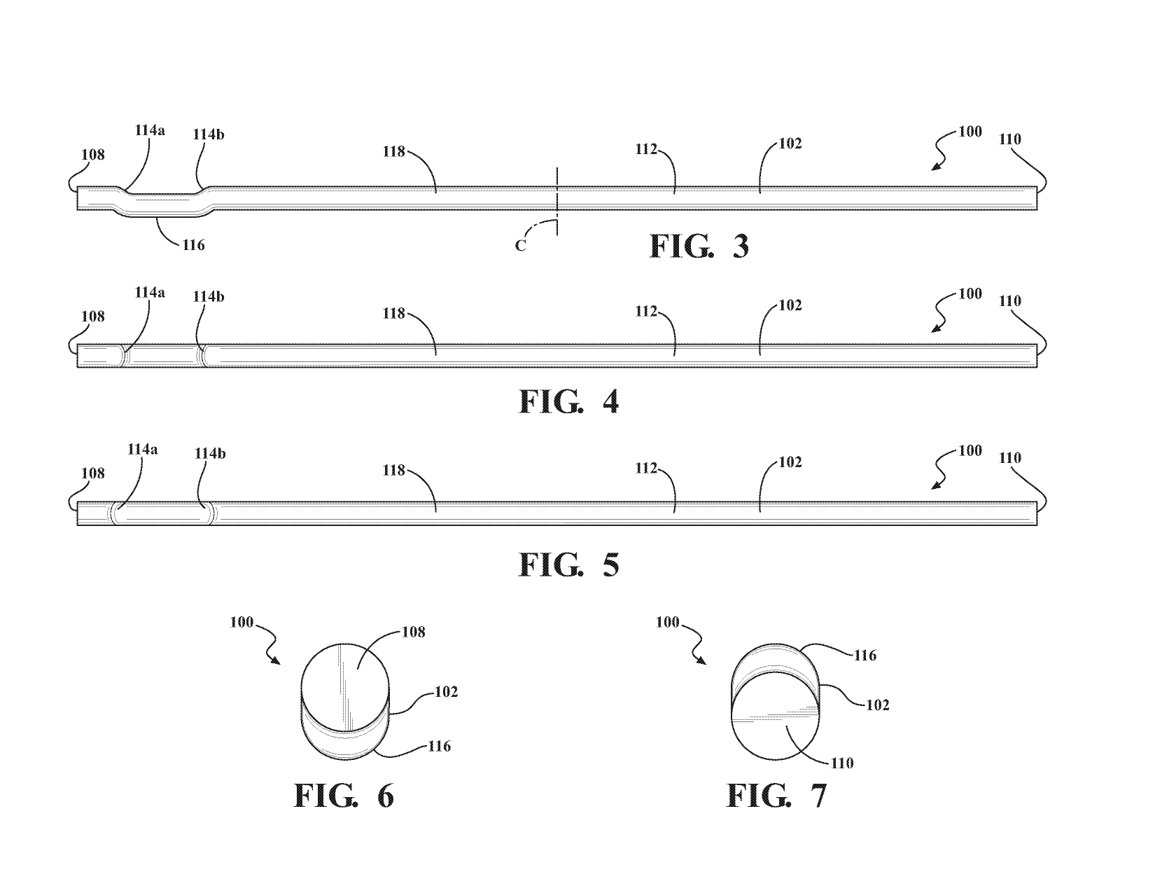

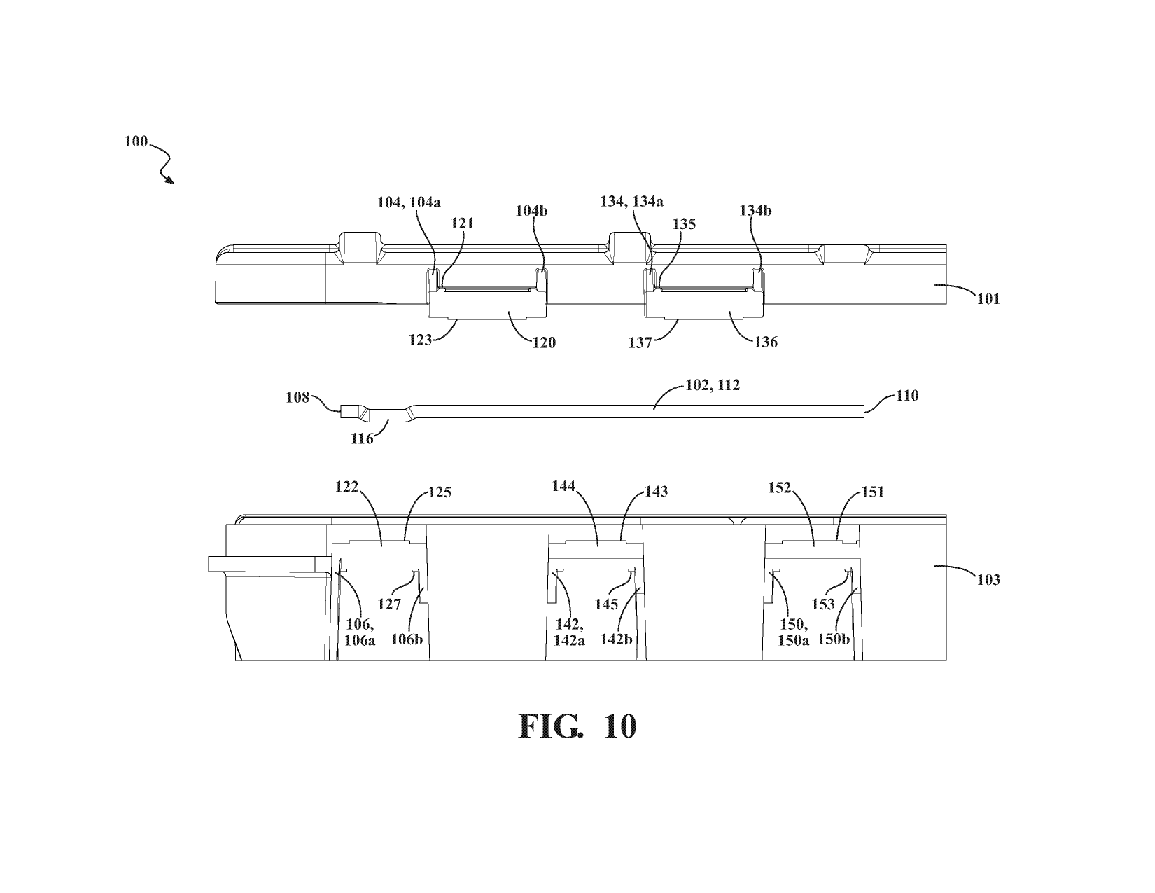

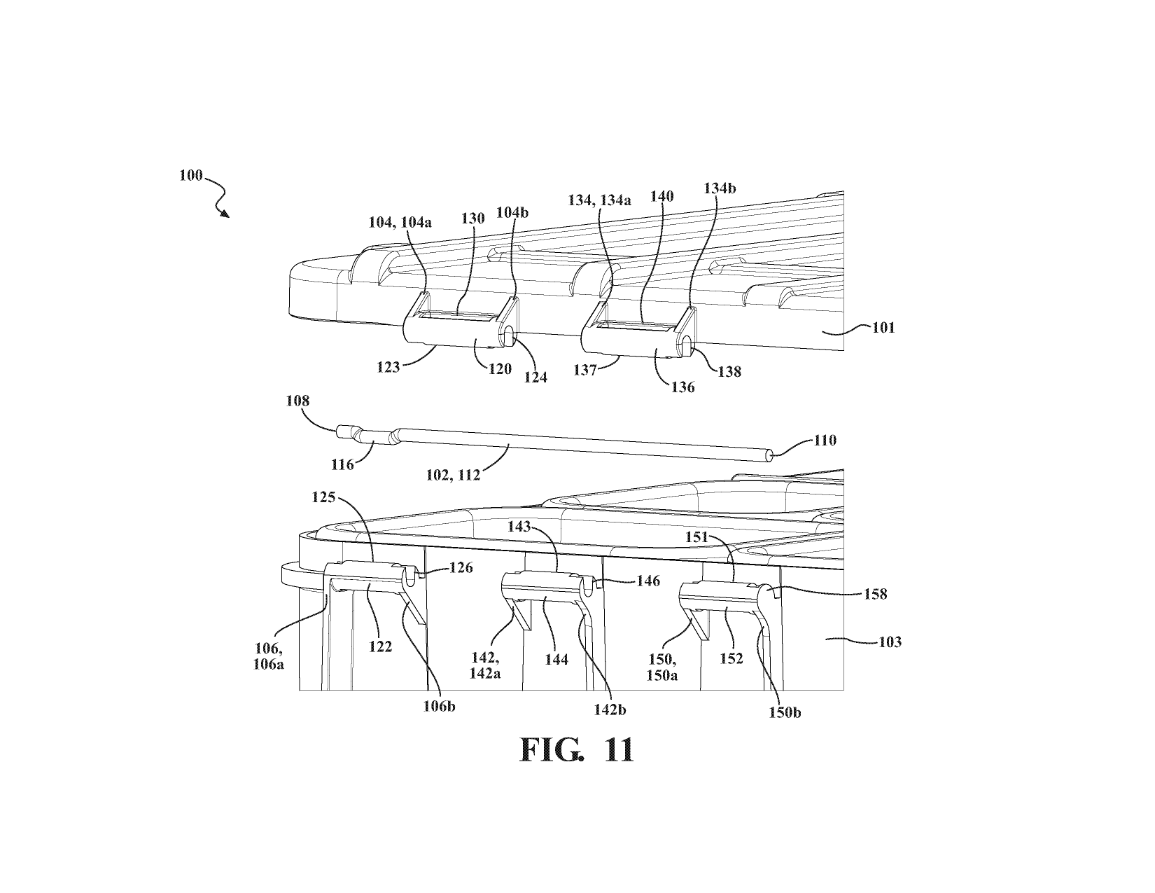

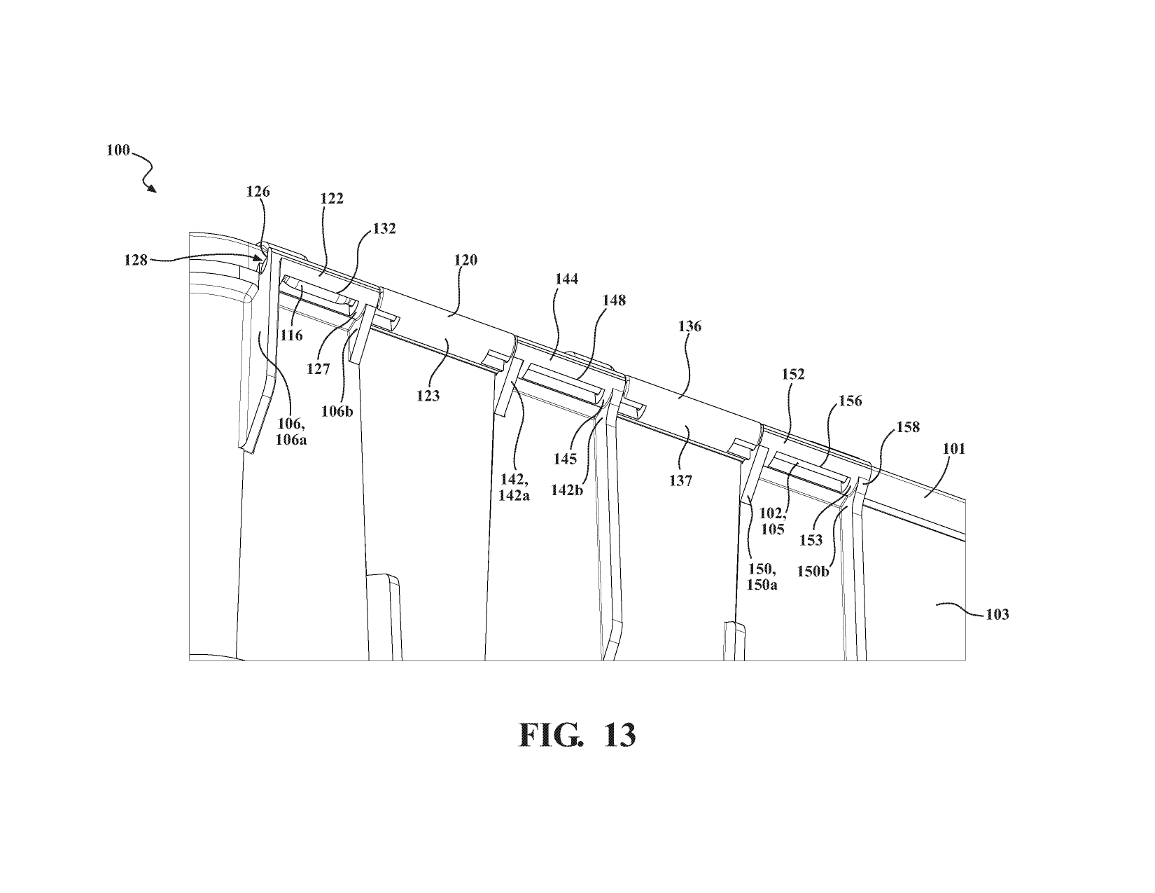

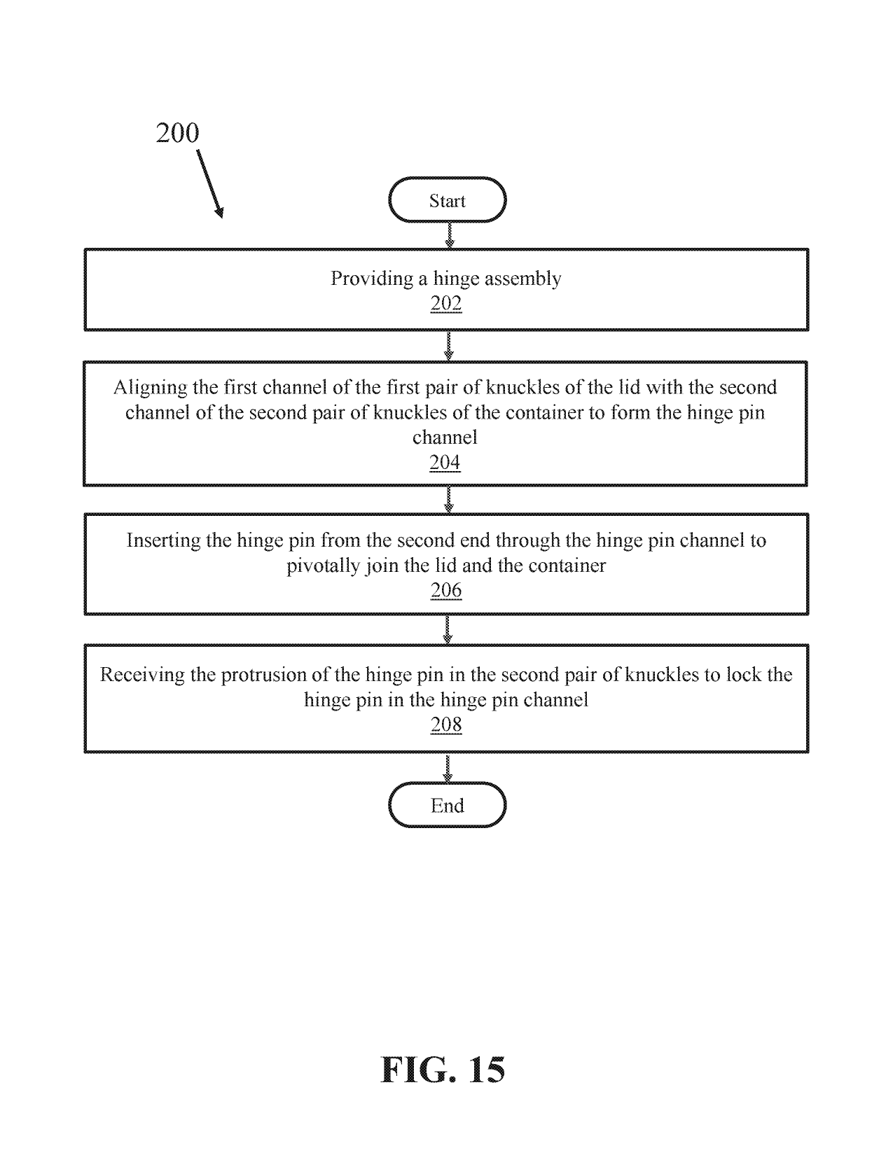

With reference to FIGS. 1-14, an embodiment of a hinge assembly 100 is provided. With reference to FIG. 15, an embodiment of a method 200 of pivotally coupling a lid 101 to a container 103 is also provided.

With particular reference to FIGS. 1-14, the hinge assembly 100 may be configured to pivotally couple the lid 101 to the container 103. The hinge assembly 100 may include the lid 101 and the container 103. The hinge assembly 100 may also include a hinge pin 102, a first pair of knuckles 104 formed on the lid 101, and a second pair of knuckles 106 formed on the container. Advantageously, the hinge assembly 100 may be configured to enhance the retention of the hinge pin 102 within the first pair of knuckles 104 and the second pair of knuckles 106 as well as provide a simplified assembly process without the need for tools or other components to pivotally couple the lid 101 to the container 103.

With reference to FIGS. 1-7, the hinge pin 102 may include a first end 108 and a second end 110. The hinge pin 102 may also include a linear portion 112. The linear portion 112 may be disposed on a first axis (A). The linear portion 112 of the hinge pin 102 may be disrupted by a bend 114 forming a protrusion 116 in the linear portion 112. The protrusion 116 may be a substantially linear protrusion 116. The linear portion 112 may include a smooth continuous surface 118 with the protrusion 116 from the first end 108 to the second end 110 of the hinge pin 102. The bend 114 may include a first bend 114a and a second bend 114b where the protrusion 116 may be disposed therebetween. The first bend 114a and the second bend 114b may disrupt the linear portion 112 to form the protrusion 116. The protrusion 116 may also be disposed on a second axis (B). In particular, the first bend 114a and the second bend 114b may position the protrusion 116 on the second axis (B) which is parallel to the first axis (A). The substantially linear protrusion 116 positioned on the second axis (B) may be parallel to the remaining linear portion 112 of the hinge pin 102 disposed on the first axis (A). The protrusion 116 may also be offset from a center axis (C) of the hinge pin 102. In other words, the first bend 114a and the second bend 114b position the protrusion 116 offset from the center axis (C) of the hinge pin 102 relative to each of the first end 108 and the second end 110 of the hinge pin.

With continued reference to FIGS. 1-7, the protrusion 116 from the first bend 114a to the second bend 114b in the linear portion 112 may include a first length (L1). The first length (L1) may be between a range of 0.5 inches to 1 inch. The first length (L1) may further be between a range of 0.5 to 0.8 inch. The first length (L1) may alternatively be in a range of 0.5 to 0.6 inches. In certain embodiments, the first length (L1) of the protrusion 116 may be approximately 0.573 inches from the first bend 114a to the second bend 114b. The first length (L1) may be 0.573 inches. The first bend 114a may also be spaced apart from the first end 108 of the hinge pin 102 at a second length (L2). The second length (L2) may be smaller than the first length (L1). The second bend 114b may be spaced apart from the second end 110 of the hinge pin 102 at a third length (L3). The third length (L3) may also be understood to define part of a length of the linear portion 112 of the hinge pin 102 as the third length (L3) may be measured from the second bend 114b to the second end 110 of the hinge pin 102 where this third length (L3) defines the linear portion 112. The third length (L3) may be larger or greater than the second length (L2) and the first length (L1). The third length (L3) may be greater than the second length (L2), which further positions the protrusion 116 offset from the center axis (C) of the hinge pin 102.

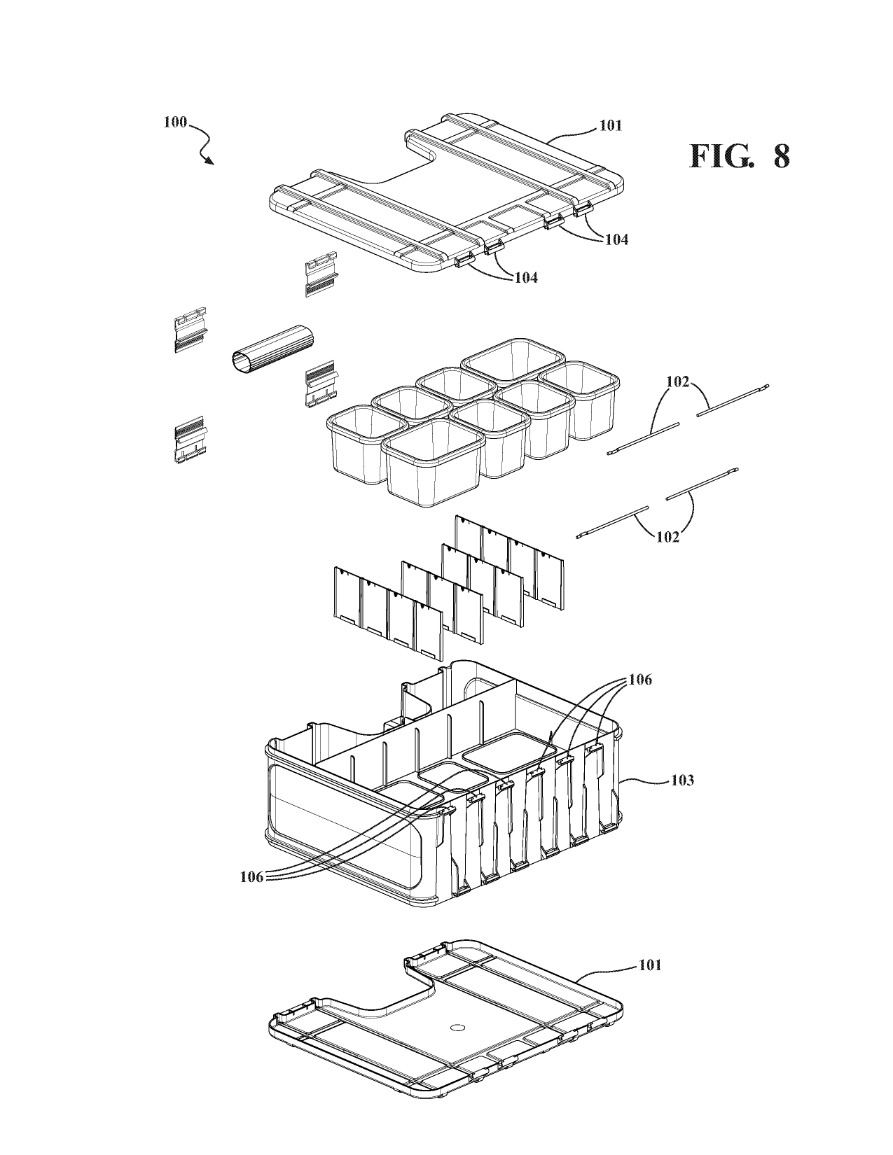

With reference to FIGS. 8-14, the first pair of knuckles 104 may be formed on the lid 101 where each knuckle 104a, 104b may be connected to one another by a first channel 120. The first pair of knuckles 104 may be formed integral to the lid 101. The first pair of knuckles 104 may be disposed adjacent an edge of the lid 101. The first pair of knuckles 104 may protrude outwardly relative to the edge of the lid 101. The first channel 120 may be disposed between the knuckle 104a and the knuckle 104b. Each of the first pair of knuckles 104a, 104b may include an aperture 124 formed therethrough. The aperture 124 may be disposed through each knuckle of the first pair of knuckles 104a, 104b to provide access to the first channel 120 for receiving a portion 105 of the hinge pin 102, as described herein. It should be understood that the first channel 120 may be configured with open ends in the form of the aperture 124 to allow the hinge pin 102 to be received therethrough.

The second pair of knuckles 106 may be formed on the container 103 where each knuckle 106a, 106b may be connected to one another by a second channel 122. The second pair of knuckles 106 may be formed integral to the container 103. The second pair of knuckles 106 may be disposed adjacent an edge of the container 103. The second pair of knuckles 106 may protrude outwardly relative to the edge of the container 103. The second channel 122 may be disposed between the knuckle 106a and the knuckle 106b. Each of the second pair of knuckles 106a, 106b may include an aperture 126 formed therethrough. The aperture 126 may also be disposed through each knuckle of the second pair of knuckles 106a, 106b to provide access to the second channel 122 for receiving the portion 105 of the hinge pin 102. The second channel 122 is similarly configured with open ends in the form of the aperture 126 to allow the hinge pin 102 to be received therethrough.

The first pair of knuckles 104a, 104b may be configured to align with the second pair of knuckles 106a, 106b. More specifically, this alignment allows the first channel 120 and the second channel 122 to cooperate to form a hinge pin channel 128 configured to receive the hinge pin 102, allowing the lid 101 to be pivotally coupled to the container 103. The hinge pin channel 128 may be configured to receive an entirety 102 of the hinge pin 102. Each of the first channel 120 and the second channel 122 may receive the portion 105 of the hinge pin 102.

With continued reference to FIGS. 8-14, the first channel 120 may include an upper wall 121 and a lower wall 123. The first channel 120 may include a first opening 130 formed through the upper wall 121 of the first channel 120 between the knuckle 104a and the knuckle 104b of the first pair of knuckles 104. The first opening 130 may be configured to be disposed opposite of the lower wall 123 of the first channel 120. The first opening 130 may include a substantially rectangular cross section or any other shaped cross section. The lower wall 123 may be configured to hold the portion 105 of the hinge pin 102 within the first channel 120. Each of the upper wall 121 and the lower wall 123 of the first channel 120 may be formed integral to one another and may be coextensive with one another.

The second channel 122 may also include an upper wall 125 and a lower wall 127. The second channel 122 may include a second opening 132 formed through the lower wall 127 of the second channel 122 between the knuckle 106a and the knuckle 106b of the second pair of knuckles 106. The second opening 132 may be configured to be disposed opposite the upper wall 125 of the second channel 122. Each of the upper wall 125 and the lower wall 127 of the second channel 122 may be formed integral to one another and may be coextensive with one another. The second opening 132 may similarly include a substantially rectangular shaped cross section or any other polygonal shaped cross section. The second opening 132 may be configured to receive the protrusion 116 of the hinge pin 102 when the first channel 120 of the first pair of knuckles 104 is aligned with the second channel 122 of the second pair of knuckles 106 to form the hinge pin channel 128. The second opening 132 may be configured in any shape similar to that of the protrusion 116 for receiving the protrusion 116 therethrough. Desirably, the second opening 132 may be configured to receive the protrusion 116 of the hinge pin 102 for securing the hinge pin 102 within the hinge pin channel 128 and militate against the hinge pin from slipping out of the hinge pin channel 128. The second opening 132 may also be understood to function as a slot for receiving the protrusion 116 and locking the hinge pin 102 within the hinge pin channel 128. Advantageously, the hinge pin 102 may be secured in the hinge pin channel 128 without the need for tools, fasteners, or other external components. More specifically, the protrusion 116 of the hinge pin 102 may be secured in the second opening 132 via a friction fit. The friction fit may be understood to define joining two parts or two components by force to create a tight connection through friction.

It should be appreciated that the configuration of the second pair of knuckles 106 is an inversion of the first pair of knuckles 104, and vice versa. Specifically, the second opening 132 formed through the lower wall 127 of the second channel may be configured identically to the first opening 130 formed through the upper wall 121 of the first channel 120, yet inverted. The identical configuration of the knuckles allows the hinge pin channel 128 to be seamlessly formed when the first pair of knuckles 104 are aligned with the second pair of knuckles 106. This militates against any obstructions or blockage of the hinge pin channel 128 to receive the hinge pin 102 therethrough.

As shown in FIGS. 8-14, the hinge assembly 100 may further include a third pair of knuckles 134 formed on the lid 101. It should be understood that the third pair of knuckles 134 may be configured identically to the first pair of knuckles 104 including each of the same components of the first pair of knuckles 104 as described herein. The third pair of knuckles 134 may be disposed adjacent to the first pair of knuckles 104. The third pair of knuckles 134 may include a third channel 136 where each knuckle 134a and knuckle 134b may be connected by the third channel 136 disposed therebetween. Each of the third pair of knuckles 134a, 134b may include an aperture 138 formed therethrough to provide access to the third channel 136 for receiving the portion 105 of the hinge pin 102. The third channel 136 may similarly include an upper wall 135 and a lower wall 137 where the upper wall 135 may include a third opening 140 formed therethrough. The lower wall 137 of the third channel 136 may be configured to hold the portion 105 of the hinge pin 102.

The hinge assembly 100 may include a fourth pair of knuckles 142 formed on the container 103. The fourth pair of knuckles 142 may be configured identically to the second pair of knuckles 106 including each of the same components of the second pair of knuckles 106 as described herein. The fourth pair of knuckles 142 may include a fourth channel 144 where each knuckle 142a and knuckle 142b may be connected by the fourth channel 144 disposed therebetween. Each of the fourth pair of knuckles 142a, 142b may include an aperture 146 formed therethrough to provide access to the fourth channel 144 for receiving the portion 105 of the hinge pin 102. The fourth channel 144 may also include an upper wall 143 and a lower wall 145 where the lower wall 145 may include a fourth opening 148.

The hinge assembly 100 may further include a fifth pair of knuckles 150 formed on the container 103. The fifth pair of knuckles 150 may be configured identically to the second pair of knuckles 106. The fifth pair of knuckles 150 may include a fifth channel 152 where each knuckle 150a and knuckle 150b may be connected by the fifth channel 152 disposed therebetween. Each of the fifth pair of knuckles 150a, 150b may include an aperture 154 disposed therethrough to provide access to the fifth channel 152 for receiving the portion 105 of the hinge pin 102. The fifth channel 152 may include an upper wall 151 and a lower wall 153 where the lower wall 153 may include a fifth opening 156.

Each of the first pair of knuckles 104 and the third pair of knuckles 134 of the lid 101, and each of the second pair of knuckles 106, the fourth pair of knuckles 142, and the fifth pair of knuckles 150 of the container 103 may collectively be aligned to form the hinge pin channel 128 for receiving the hinge pin 102 and pivotally coupling the lid 101 to the container 103. Desirably, the hinge assembly 100 militates against the need for tools, fasteners, or other external components to pivotally couple the lid 101 to the container 103.

The fifth pair of knuckles 150 may further include a closed end 158 formed in the knuckle 150b. The closed end 158 may replace the aperture 154 formed in the knuckle 150b. Particularly, the knuckle 150a may include the aperture 154 to receive the hinge pin 102 but the knuckle 150b may include the closed end 158 to terminate the hinge pin channel 128. The closed end 158 may be configured to terminate the hinge pin channel 128 for receiving the hinge pin 102. The closed end 158 may also be configured as a closed wall, a stopper, or the like, to terminate the hinge pin channel 128. The closed end 158 may be disposed adjacent the second end 110 of the hinge pin 102 when the hinge pin 102 is received through the hinge pin channel 128 formed by each of the first pair of knuckles 104, the second pair of knuckles 106, the third pair of knuckles 134, the fourth pair of knuckles 142, and the fifth pair of knuckles 150 in alignment.

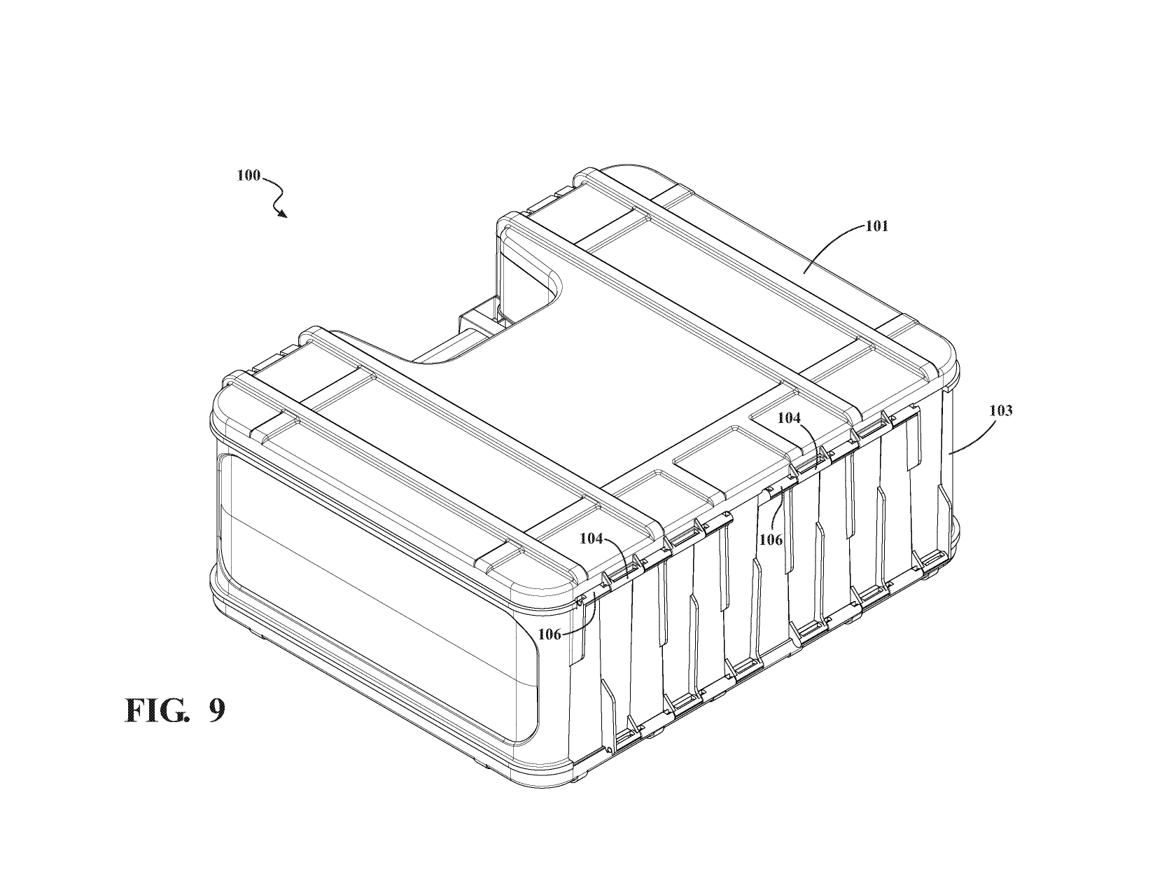

It should be appreciated that the hinge assembly 100 may be configured with any suitable pair of knuckles. More specifically, the hinge assembly 100 may be configured with the first pair of knuckles 104 and the second pair of knuckles 106. The hinge assembly 100 may be configured with three pairs of knuckles, four pairs of knuckles, five pairs of knuckles, or more. For purposes of illustration, the hinge assembly 100 may be configured with five pairs of knuckles as shown in FIGS. 9-14. However, one of ordinary skill in the art may select a suitable amount of knuckles to configure the hinge assembly 100 for coupling the lid 101 to the container 103. It should be appreciated that the closed end 158 may be configured to terminate the hinge pin channel 128 based on the amount of knuckles provided in the hinge assembly 100 and the closed end 158 may be provided as the very last knuckle of the hinge assembly 100. The closed end 158 may be provided in the very last knuckle of the hinge assembly 100 adjacent the second end 110 of the hinge pin 102. The closed end 158 may be configured to be disposed adjacent the second end 110 of the hinge pin 102 when the hinge pin 102 is received in the hinge pin channel 128 to terminate the hinge pin channel 128. The closed end 158 may be configured to secure the hinge pin 102 within the hinge pin channel 128.

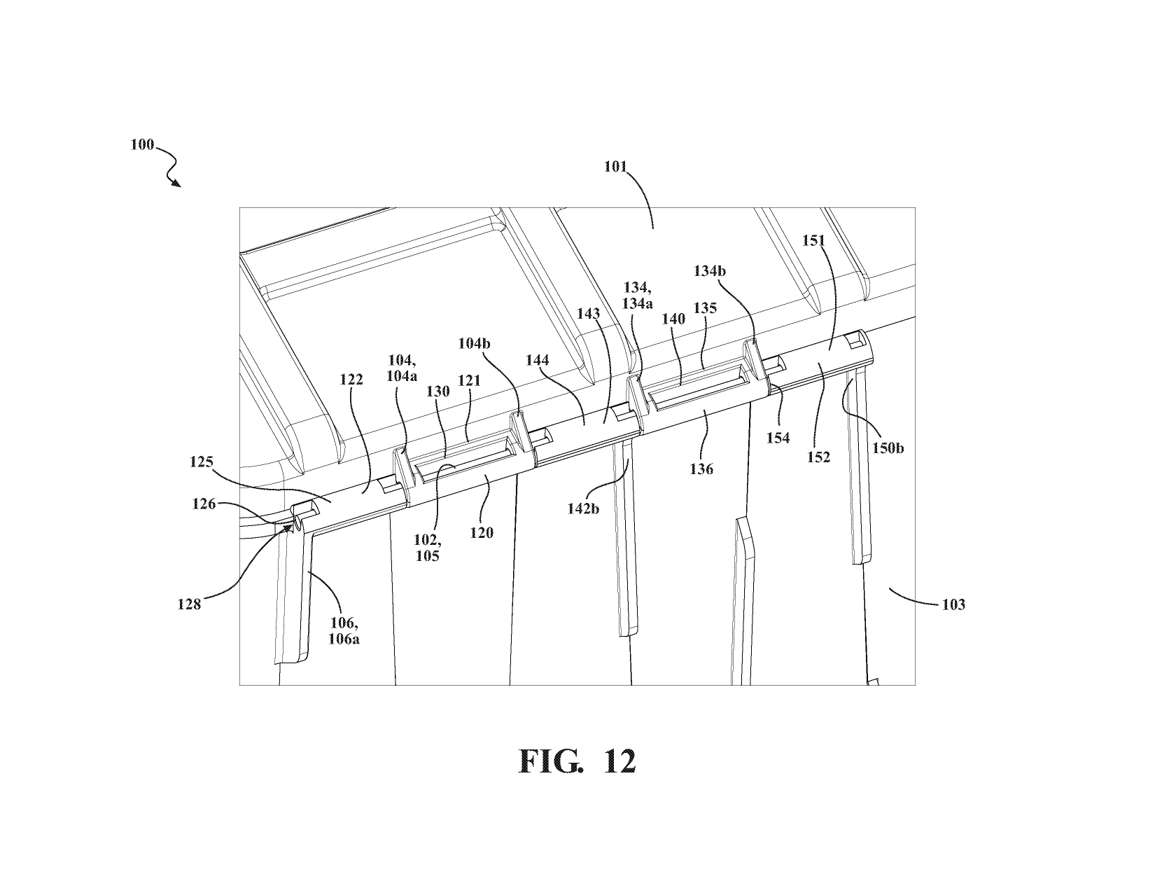

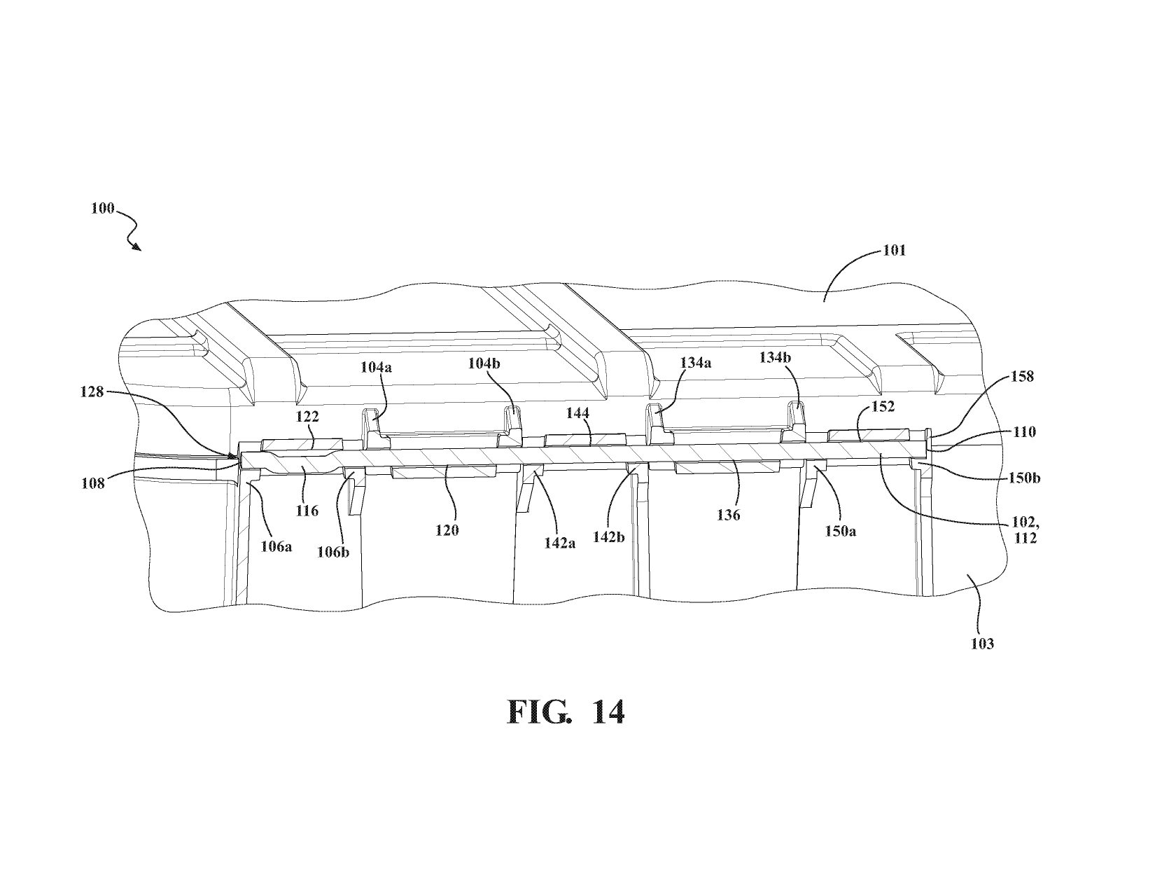

In operation, the lid 101 may be aligned with the container 103. Specifically, each of the first pair of knuckles 104 and the third pair of knuckles 134 of the lid 101 may be aligned with the second pair of knuckles 106, the fourth pair of knuckles 142, and the fifth pair of knuckles 150 to form the hinge pin channel 128. As shown in FIGS. 12-14, all of the pair of knuckles may be disposed along a common horizontal axis when aligned together to form the hinge pin channel 128. This common horizontal axis may allow the hinge pin 102 to be received through the hinge pin channel 128 for pivotally coupling the lid 101 to the container 103. Importantly, all of the pair of knuckles may be disposed on the first axis (A) common to the linear portion 112 as described hereinabove. When the lid 101 and the container 103 are aligned to form the hinge pin channel 128, as shown in FIG. 14, the second end 110 of the hinge pin 102 may be received through the second channel 122, the first channel 120, the fourth channel 144, and the third channel 136. The protrusion 116 of the hinge pin 102 may then be forcefully pushed through to snap into the second opening 132 of the second channel 122. More specifically, the second bend 114b may abut the knuckle 106a of the second pair of knuckles 106 before the hinge pin 102 is secured in the hinge pin channel 128. Forcefully pushing the hinge pin 102 through the aperture 126 of the knuckle 106a allows each of the first bend 114a and the second bend 114b to position the protrusion 116 within the second opening 132 of the second channel 122. Ultimately, once the protrusion 116 is secured within the second opening 132, the second end 110 of the hinge pin 102 may then be received through the fifth channel 152 while the protrusion 116 remains positioned in the second opening 132 for securing the hinge pin 102 in the hinge pin channel 128. The protrusion 116 cooperating with the second opening 132 of the second channel 122 may function as a locking mechanism to lock and secure the hinge pin 102 within the hinge pin channel 128, providing enhanced retention of the hinge pin 102 within the hinge pin channel 128. Desirably, the second opening 132 of the second channel 122 positions the protrusion, disposed on the second axis (B) through the second opening 132 while the remaining linear portion 112 is disposed on the first axis (A), allowing the hinge pin 102 to be secured in the hinge pin channel 128 without risk of sliding out or loosening thereof. The closed end 158 of the knuckle 150b may further militate against potential slipping, sliding, or loosening of the hinge pin 102 within the hinge pin channel 128.

As shown in FIGS. 12-14, the second pair of knuckles 106 may receive the second end 110 of the hinge pin 102. Importantly, the second pair of knuckles 106 may also receive the protrusion 116 of the hinge pin 102 to lock the hinge pin 102 within the hinge pin channel 128. However, it should be appreciated that the alignment of the first channel 120, the second channel 122, the third channel 136, the fourth channel 144, and the fifth channel 152 may be configured in any configuration to receive the protrusion 116 of the hinge pin 102 for locking the hinge pin 102 within the hinge pin channel 128.

It should be appreciated that one of ordinary skill in the art may include any number of the pair of knuckles to configure the hinge assembly 100, as described herein. The hinge assembly 100 may also be configured to include another hinge assembly 100’ to pivotally couple the lid 101 to the container 103. The hinge assembly 100 may include another three hinge assemblies or four hinge assemblies to couple multiple lids to the container 103. One of ordinary skill in the art may select a suitable configuration within the scope of the present disclosure.

The hinge assembly 100 may also be formed of a plastic material. The plastic material may be a lightweight plastic material such as polyolefin plastic including polypropylene, or any other suitable material such as thermoplastic material. One of ordinary skill in the art may select a suitable plastic to form the lid 101, the container 103, and the hinge pin 102 of the hinge assembly 100 within the scope of the present disclosure. The hinge assembly 100 may also be formed using a plastic injection molding process. Each of the lid 101, the hinge pin 102, and the container 103 may be formed of the plastic material. Alternatively, the lid 101 and the container 103 may be formed of the plastic material while the hinge pin 102 may be formed of a metal. The metal may include steel such as stainless steel, aluminum, or any other suitable metal within the scope of the present disclosure. One of ordinary skill in the art may select a suitable material to form the hinge assembly 100 within the scope of the present disclosure.

As shown in FIG. 15, the method 200 may include a step 202 of providing the hinge assembly 100 as described herein. The method 200 may include a step 204 of aligning the first channel 120 of the first pair of knuckles 104 of the lid 101 with the second channel 122 of the second pair of knuckles 104 of the container 103 to form the hinge pin channel 128. The step 204 may also include aligning each of the first channel 120 and the third channel 136 of the lid 101 with the second channel 122, the fourth channel 144, and the fifth channel 152 of the container 103 to collectively form the hinge pin channel 128 for receiving the hinge pin 102. The method 200 may include a step 206 of inserting the hinge pin 102 from the second end 110 through the hinge pin channel 128 to pivotally join the lid 101 and the container 103. The method 200 may include a step 208 of receiving the protrusion 116 of the hinge pin 102 in the second opening 132 of the second channel 122 to lock the hinge pin 102 within the hinge pin channel 128.

Advantageously, the hinge assembly 100 provides an enhanced retention of the hinge pin 102 within the hinge pin channel 128 while militating against the need for tools, fasteners, or other external components to pivotally couple the lid 101 to the container 103. Desirably, this provides a simplified assembly process that is easy and effective. The linear portion 112 and the protrusion 116 of the hinge pin 102 cooperates with the second opening 132 formed in the second channel 122 to function as a locking mechanism that secures the hinge pin 102 within the hinge pin channel 128 through a friction fit, without risk of sliding out or loosening. Desirably, this militates against complex assemblies which could otherwise require additional hardware and tools for installation.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure.

In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A hinge assembly for coupling a lid to a container, comprising:
a hinge pin including a first end, a second end, and a linear portion disrupted by a bend forming a protrusion in the linear portion;
a first pair of knuckles formed on the lid where each knuckle is connected by a first channel; and
a second pair of knuckles formed on the container where each knuckle is connected by a second channel, the first pair of knuckles configured to align with the second pair of knuckles whereby the first channel and the second channel cooperate to form a hinge pin channel configured to receive the hinge pin.

2. The hinge assembly of claim 1, wherein the linear portion includes a smooth continuous surface with the protrusion from the first end to the second end of the hinge pin.

3. The hinge assembly of claim 1, wherein the bend includes a first bend and a second bend with the protrusion disposed therebetween, each of the first bend and the second bend disrupting the linear portion of the hinge pin to form the protrusion.

4. The hinge assembly of claim 3, wherein the linear portion is disposed on a first axis and the protrusion is disposed on a second axis parallel to the first axis.

5. The hinge assembly of claim 4, wherein each of the first bend and the second bend are configured to position the protrusion on the second axis parallel to the first axis, the protrusion substantially linear in shape.

6. The hinge assembly of claim 5, wherein the protrusion in the linear portion from the first bend to the second bend includes a length between a range of 0.5 inches to 1 inch.

7. The hinge assembly of claim 1, wherein the protrusion is offset from a center of the hinge pin relative to each of the first end and the second end of the hinge pin.

8. The hinge assembly of claim 1, wherein each knuckle of the first pair of knuckles and the second pair of knuckles includes an aperture, the aperture disposed through each knuckle of the first pair of knuckles and the second pair of knuckles, respectively.

9. The hinge assembly of claim 8, wherein the aperture of the first pair of knuckles and the second pair of knuckles allows the first channel and the second channel to cooperate to form the hinge pin channel for receiving the hinge pin when the first pair of knuckles is aligned with the second pair of knuckles.

10. The hinge assembly of claim 1, wherein the hinge pin channel receives an entirety of the hinge pin and each of the first channel and the second channel receive a portion of the hinge pin.

11. The hinge assembly of claim 1, wherein the first pair of knuckles include a first opening formed through an upper wall of the first channel between each knuckle of the first pair of knuckles.

12. The hinge assembly of claim 11, wherein the second pair of knuckles includes a second opening formed through a lower wall of the second channel disposed between each knuckle of the second pair of knuckles.

13. The hinge assembly of claim 12, wherein the second opening of the second pair of knuckles is configured to receive the protrusion of the hinge pin when the first pair of knuckles and the second pair of knuckles are aligned to form the hinge pin channel to pivotally couple the lid and the container.

14. The hinge assembly of claim 13, wherein the protrusion is configured to secure the hinge pin within the hinge pin channel via a friction fit.

15. The hinge assembly of claim 1, further including a third pair of knuckles formed on the lid where each knuckle is connected by a third channel.

16. The hinge assembly of claim 15, further including:
a fourth pair of knuckles formed on the container where each knuckle is connected by a fourth channel,
a fifth pair of knuckles formed on the container where each knuckle is connected by a fifth channel, and
each of the first pair of knuckles and the third pair of knuckles of the lid are configured to align with each of the second pair of knuckles, the fourth pair of knuckles, and the fifth pair of knuckles of the container to collectively form the hinge pin channel configured to receive the hinge pin.

17. The hinge assembly of claim 16, further including a closed end formed in one knuckle of the fifth pair of knuckles, the closed end configured to terminate the hinge pin channel for receiving the hinge pin.

18. The hinge assembly of claim 17, wherein the closed end is configured to be disposed adjacent to the second end of the hinge pin when the hinge pin is received through the hinge pin channel for pivotally coupling the lid and the container.

19. The hinge assembly of claim 4, wherein:
the linear portion includes a smooth continuous surface with the protrusion from the first end to the second end of the hinge pin,
the bend includes a first bend and a second bend with the protrusion disposed therebetween, each of the first bend and the second bend disrupting the linear portion of the hinge pin to form the protrusion,
the linear portion is disposed on a first axis and the protrusion is disposed on a second axis parallel to the first axis,
each of the first bend and the second bend are configured to position the protrusion on the second axis parallel to the first axis, the protrusion substantially linear in shape,
the protrusion is offset from a center of the hinge pin relative to each of the first end and the second end of the hinge pin,
the protrusion in the linear portion from the first bend to the second bend includes a length between a range of 0.5 inch to 1 inch,
each knuckle of the first pair of knuckles and the second pair of knuckles includes an aperture, the aperture disposed through each knuckle of the first pair of knuckles and the second pair of knuckles, respectively,
the aperture of the first pair of knuckles and the second pair of knuckles allows the first channel and the second channel to cooperate to form the hinge pin channel for receiving the hinge pin when the first pair of knuckles is aligned with the second pair of knuckles,
the hinge pin channel receives an entirety of the hinge pin and each of the first channel and the second channel receive a portion of the hinge pin,
the first pair of knuckles include a first opening formed through an upper wall of the first channel between each knuckle of the first pair of knuckles,
the second pair of knuckles includes a second opening formed through a lower wall of the second channel disposed between each knuckle of the second pair of knuckles,
the second opening of the second pair of knuckles is configured to receive the protrusion of the hinge pin when the first pair of knuckles and the second pair of knuckles are aligned to form the hinge pin channel to pivotally couple the lid and the container,
the protrusion is configured to secure the hinge pin within the hinge pin channel via a friction fit,
the hinge assembly further includes a third pair of knuckles formed on the lid where each knuckle is connected by a third channel,
the hinge assembly further includes a fourth pair of knuckles formed on the container where each knuckle is connected by a fourth channel, a fifth pair of knuckles formed on the container where each knuckle is connected by a fifth channel, each of the first pair of knuckles and the third pair of knuckles of the lid are configured to align with each of the second pair of knuckles, the fourth pair of knuckles, and the fifth pair of knuckles of the container to collectively form the hinge pin channel configured to receive the hinge pin,
the hinge assembly further includes a closed end formed in one knuckle of the fifth pair of knuckles, the closed end configured to terminate the hinge pin channel for receiving the hinge pin, and
the closed end is configured to be disposed adjacent to the second end of the hinge pin when the hinge pin is received through the hinge pin channel for pivotally coupling the lid and the container.

20. A method of coupling a lid to a container, comprising:
providing a hinge assembly including:
a hinge pin including a first end, a second end, and a linear portion disrupted by a bend forming a protrusion in the linear portion,
a first pair of knuckles formed on the lid where each knuckle is connected by a first channel, and
a second pair of knuckles formed on the container where each knuckle is connected by a second channel, the first pair of knuckles configured to align with the second pair of knuckles whereby the first channel and the second channel cooperate to form a hinge pin channel configured to receive the hinge pin;
aligning the first channel of the first pair of knuckles of the lid with the second channel of the second pair of knuckles of the container to form the hinge pin channel;
inserting the hinge pin from the second end through the hinge pin channel to pivotally join the lid and the container; and
receiving the protrusion of the hinge pin in the second pair of knuckles to lock the hinge pin in the hinge pin channel.
